(19) United States
(12) Patent Application Publication
(10) Pub. No.: US 2007/0135153 A1
(43) Pub. Date: Jun. 14, 2007

(54) Methods and apparatus for providing a transmit signal strength message

(76) Inventors: Zhijun Cai, Euless, TX (US); Mansoor Ahmed, Fort Worth, TX (US); Richard C. Burbidge, Hook (GB); Robert M. Harrison, Grapevine, TX (US)

Correspondence Address: MOTOROLA, INC., 1303 EAST ALGONQUIN ROAD, IL01/3RD, SCHAUMBURG, IL, 60196, US

(21) Appl. No.: 11/299,599

(22) Filed: Dec. 12, 2005

(51) Int. Cl. H04B 7/00

(52) U.S. Cl. 455/522

(57) ABSTRACT

Methods and apparatus for providing a transmit signal strength message. According to one embodiment of the invention, a transmit signal strength message is generated (212) using a first cell based, at least in part, on transmit signal power levels of the first cell and a second cell, which is then sent (214) for broadcast through the first cell.

### TECHNICAL FIELD

This invention relates generally to a technique for providing a transmit signal strength message.

### BACKGROUND

Current communication networks typically set different power levels for each transport channel (e.g., such as a Forward Access Channel (“FACH”)) on a physical channel (e.g., such as a Secondary Common Control Physical Channel (“S-CCPCH”)). The power of the FACH, however, is not transmitted to the user equipment (“UE”). In cases of a low rate service on a simply configured S-CCPCH, this may be acceptable, but for Multimedia Broadcast and Multicast Services, this limitation is problematic, especially for macro-diversity configurations.

For example, higher data rates and more complex S-CCPCH configurations (e.g., multiple FACH instances being at different power levels) are generally more desired when using Multimedia Broadcast and Multicast Services (“MBMS”). Since the UE must estimate the FACH power at the start of a transmission, the buffering requirements will increase and/or decoding performance is degraded until enough frames have been received to estimate power. Furthermore, to allow for the best macro-diversity reception, the UE must know the ratio of the power level between the serving cell and the neighboring cells in order to soft combine MBMS transmission from the cells (e.g., using maximum ratio combining).

Furthermore, the current communication networks are simply not equipped to effectively accommodate the Multimedia Broadcast and Multicast Services when traffic congestion occurs. One proposed solution is to reduce the rate of the Multimedia Broadcast and Multicast Service data stream when traffic congestion occurs. This solution, however, discards data blocks transmitted from cells and so may reduce the reception performance.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 comprises a block diagram of a wireless communication system in accordance with an embodiment of the present invention;

FIG. 2 comprises a flow chart diagram of a transmit process according to an embodiment of the invention; and

FIG. 3 comprises a flow chart diagram of an adjustment process according to an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION

Generally speaking, pursuant to these various embodiments, a transmit signal strength message is generated using a first cell based, at least in part, on transmit signal power levels of the first cell and a second cell, which is then sent for broadcast through the first cell.

In one specific embodiment, a ratio of a transmit signal power level on a first cell relative to a second cell is assessed based, at least in part, on a criterion. The transmit signal strength message is then generated that is based, at least in part, on this ratio, and the transmit signal message is accordingly sent for broadcast using the first cell.

Further according to various embodiments, a second ratio of a transmit signal power level on the first cell relative to the second cell is further assessed based, at least in part, on the same criterion or a second criterion that is different from the criterion. This second ratio is similarly used to generate a second transmit signal strength message and sent for broadcast on the first cell. In other embodiments, prior to the assessment of the ratio, current transmit signal power level of the first and second cell are assessed. For one embodiment, the ratio of the transmit signal power level includes an integer value. In an embodiment, the transmit signal strength message for broadcast using the first cell is sent over a broadcast control channel and/or a multicast control channel.

Specifically, according to one embodiment, the current transmit signal power level of the first and second cell are used to determine whether there is inadequate transmit signal power level on one of the first and second cells. If there is, in fact, inadequate transmit signal power level on one of the first and second cells, the transmit signal power level of inadequate cell is adjusted.

For a particular embodiment, prior to the assessment of the ratio, a current transmit signal power level of at least two cells is assessed. Similarly, a determination as to whether there is inadequate transmit signal power level on one of the at least two cells is made. Again, if there is inadequate transmit signal power level on one of the cells, the transmit signal power level of the inadequate cell is adjusted.

According to various embodiments, a transmit signal strength message is received, which is specifically based, at least in part, on a ratio of a transmit signal power level on a first cell relative to a second cell. The macro-diversity reception is then adjusted based, at least in part, on this transmit signal strength message. In specific embodiments, the macro-diversity reception is adjusted using cell selection, maximum-ratio combining, and/or selection combining.

According to various embodiments, an apparatus is also included along with a memory having a ratio of a transmit signal power level on a first cell relative to a second cell based, at least in part, on a criterion stored therein. A controller that is operably coupled to the memory is also included, which is configured to generate a transmit signal strength message based, at least in part, on the ratio, and the transmit signal strength message is sent for broadcast on the first cell. In a particular embodiment, the ratio of the transmit signal power level comprises an integer value. The transmit signal strength message for broadcast on the first cell, according to an embodiment, includes a broadcast control channel and/or a multicast control channel.

For one specific embodiment, the memory further comprises a second ratio of a transmit signal power level on the first cell relative to the second cell based, at least in part, on the criterion stored therein, wherein the controller is further configured to generate a second transmit signal strength message based, at least in part, on the second ratio. The controller accordingly sends the second transmit signal strength message for broadcast on the first cell. In another embodiment, the memory further comprises a second ratio of a transmit signal power level on the first cell relative to the second cell based, at least in part, on a second criterion that is different from the criterion and where the controller is further configured to generate a second transmit signal strength message based, at least in part, on the second ratio and send the second transmit signal strength message for broadcast on the first cell.

These various embodiments provide a more efficient way for adjusting macro-diversity reception while accommodating the complexity of Multimedia Broadcast and Multicast Services. The network signals the neighboring cell's relative power offset to the serving cell. During decoding, the UE is enabled to read this power offset information for macro-diversity reception. More specifically, the UE may use this power offset information for two purposes.

The first purpose is that the UE may use the power offset information to select the strongest of the macro-diversity signals that may be combined beneficially. In this case, the UEs, themselves, determine the received power level of a pilot such as a Common Pilot Channel (“CPICH”) of a neighboring cell and use the power offset from the CPICH to calculate the power that the MBMS data will receive at from the neighboring cell. For example, when a UE uses MBMS selection combining, this ability to determine the strongest macro-diversity signals will ensure the best selection combining performance. Specifically, selection combining generally requires the UE to decode a uniquely identifiable block of MBMS data multiple times, because the data block is decoded once from each of the macro-diverse cells that the UE is simultaneously receiving from.

The second purpose is that the UE may weight (e.g., multiply) each of the combinable received macro-diverse signals with a factor proportional to the received MBMS signal power. Using soft combining, the received MBMS signals can, therefore, be combined using well-known Max-Ratio Combining techniques. If the UE cannot determine the received MBMS signal power from a neighbor cell, it cannot determine an optimal combining weight, degrading the soft combining performance. Furthermore, as in the case of selection combining, determining the strongest macro-diversity cells will ensure the best soft combining performance.

In another embodiment, the disclosed method provides an efficient way for allowing the network to adjust the power of the signals when the network congestion occurs. In particular, when congestion occurs, the rate of the data stream is unchanged, while the transmission power is reduced. For example, when congestion occurs from a mix of Multimedia Broadcast/Multicast Services and other services, the network may choose to reduce the power on certain Multimedia Broadcast and Multicast Services channels in the serving cell to accommodate data transmission of higher priority services. The network may also choose to increase a neighboring cell's power if there is additional power available, which ultimately improves and maintains coverage. As a result, the power management provided by the various teachings is better suited for complex networks having different priorities, such as the use of Multimedia Broadcast and Multicast Services.

As required, detailed embodiments of the present invention are disclosed herein. However, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but, rather, to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

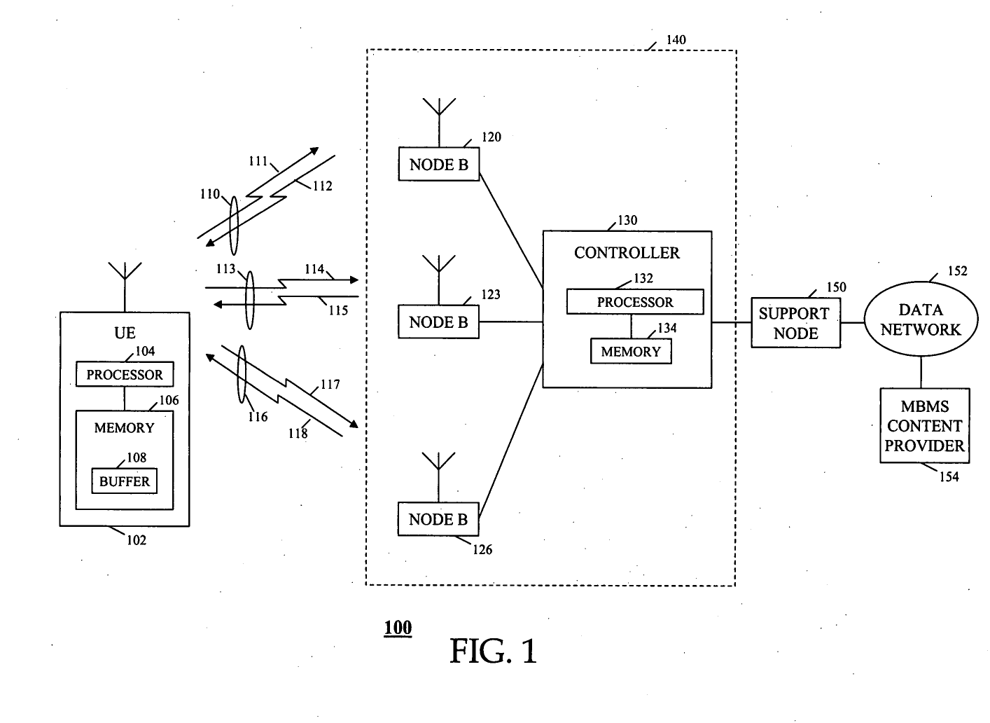

Referring now to the drawings, and in particular to FIG. 1, for purposes of providing an illustrative but non-exhaustive example to facilitate this description, a specific operational paradigm using a wireless communication system is shown and indicated generally at numeral reference 100. Those skilled in the art, however, will recognize and appreciate that the specifics of this illustrative example are not specific to the invention itself and that the teachings set forth herein are applicable in a variety of alternative settings. For example, since the teachings described are not platform dependent, they can be applied to various systems, such as, but not limited to, Code Division Multiple Access (CDMA) systems, Time Division Multiple Access (TDMA) systems, Universal Mobile Telecommunications Systems (“UMTSs”), and General Packet Radio Service (“GPRS”) systems. In fact, any communication network that requires power management for transmission of data is contemplated, and these various embodiments are within the scope of the invention.

Communication system 100 includes multiple base stations (“Node Bs”) 120, 123, and 126 (three shown). Each Node B 120, 123, 126 is operably coupled to a network controller 130, preferably a Radio Network Controller (RNC); however, in another embodiment of the present invention, one or more of Node Bs 120, 123, 126 may be coupled to a different network controller, wherein each such network controller is coupled to the other network controllers. When one or more of Node Bs 120, 123, and 126 is coupled to a different network controller than the other Node Bs, the references herein to network controller 130 may be deemed to collectively refer to all such network controllers, as the functions described herein may be distributed among such network controllers. Each Node B 120, 123, 126 provides wireless communication services to a corresponding coverage area, through a cell, which may cover a portion or sector of the area served by a Node B, via a respective air interface 110, 113, and 116. Together, the multiple Node Bs 120, 123, 126 and network controller 130 are collectively referred to herein as a Radio Access Network (RAN) 140.

Each air interface 110, 113, 116 comprises a respective downlink (DL) 112, 115, 118 having multiple downlink logical and transport channels, including at least one broadcast channel, at least one traffic channel, and at least one control channel, that may be mapped to one or more of multiple downlink physical channels, including at least one common control channel, at least one dedicated channel, and at least one pilot channel. Each air interface 110, 113, 116 further comprises a respective uplink (UL) 111, 114, 117 having multiple uplink logical and transport channels, including an access channel, at least one traffic channel, and at least one control channel, that may be mapped to one or more of multiple uplink physical channels.

The communication system 100 further includes at least one user equipment (UE) 102 (one shown), such as but not limited to a cellular telephone, a radio telephone, a personal digital assistant (PDA) with radio frequency (RF) capabilities, or a wireless modem that provides RF access to digital terminal equipment (DTE) such as a laptop computer. This UE 102 resides in a coverage area serviced by a serving Node B, that is, Node B 123, of the multiple Node Bs. This UE 102 may soft combine Multimedia Broadcast/Multicast Service (MBMS) transmissions from cells of one or more neighbor Node Bs in addition to transmissions from a serving cell of a serving Node B 123, such as one or more of Node Bs 120 and 126.

This UE 102 subscribes to, and is capable of receiving and displaying audio, video, and/or data associated with, a Multimedia Broadcast/Multicast Service (an MBMS service) provided by the communication system 100, which service provides for a distribution of MBMS data to the UE. MBMS services are described in detail in the 3GPP TS 25.344 (Third Generation Partnership Project Technical Specification 25.344), 3GPP TS 23.246, 3GPP TS 23.846, 3GPP TS 25.331, and 3GPP TS 25.346, which specifications and reports are hereby incorporated by reference herein and copies of which may be obtained from the 3 GPP via the Internet or from the 3 GPP Organization Partners'Publications Offices at Mobile Competence Centre 650, route des Lucioles, 06921 Sophia-Antipolis Cedex, France.

Communication system 100 further includes a Support Node 150 coupled to network controller 130. Support Node 150 typically includes one or more Serving General Packet Radio Service (GPRS) Support Nodes (SGSNs) that are each coupled to one or more Gateway GPRS Support Nodes (GGSNs). However, the precise architecture of this Support Node 150 is up to an operator of the communication system 100 and is not critical to the present invention. Although not shown, this communication system 100 may further include other well-known network elements, such as a Broadcast Multicast Service Center (BM-SC) or a Gateway.

The communication system 100 further includes an MBMS content provider 154, such as an IP multicast server, that is coupled to support node 150 via a data network 152, such as an IP network. As part of an MBMS service provided by communication system 100 and subscribed to by UE 102, MBMS content provider 154 sources MBMS data, typically in the form of IP data packets, to subscribed UE 102 via support node 150, controller 130, serving Node B 123, and one or more of neighboring Node Bs 120 and 126.

Each of UE 102 and controller 130 includes a respective processor 104, 132 such as one or more microprocessors, microcontrollers, digital signal processors (DSPs), combinations thereof or such other devices known to those having ordinary skill in the art. The particular operations/functions of processors 104 and 132, and respectively thus of UE 102 and controller 130, are determined by an execution of software instructions and routines that are stored in a respective at least one memory device 106, 134 associated with the processor, such as random access memory (RAM), dynamic random access memory (DRAM), and/or read only memory (ROM) or equivalents thereof, that store data and programs that may be executed by the corresponding processor. In order for UE 102 to soft combine MBMS transmissions from cells of multiple Node Bs, at least one memory device 106 of UE 102 further comprises a soft combining buffer 108 that stores MBMS data received from each cell (or “soft information”) of the multiple Node Bs 120, 123, 126 until the data can be soft combined with a same MBMS data received from cells of the other Node Bs of the multiple Node Bs.

These illustrative embodiments are implemented within UE 102 and controller 130, and more particularly with or in software programs and instructions stored in the respective at least one memory device 106, 134, and executed by respective processors 104, 132. However, one of ordinary skill in the art realizes that the embodiments of the present invention alternatively may be implemented in hardware, for example, integrated circuits (ICs), application specific integrated circuits (ASICs), and the like, such as ASICs implemented in one or more of the wireless communication devices UE 102 and transceiver 123. Based on the present disclosure, one skilled in the art will be readily capable of producing and implementing such software and/or hardware without undo experimentation.

According to various embodiments, the memory device 134 stores the ratio of a transmit signal power level on a first cell relative to a second cell based, at least in part, on a criterion stored therein. The controller, on the other hand, generates the transmit signal strength message based, at least in part, on the ratio and sends the transmit signal strength message for broadcast on the first cell. The ratio of the transmit signal power level, according to one embodiment, includes an integer value. In an embodiment, the transmit signal strength message for broadcast on the first cell further includes a broadcast control channel and/or a multicast control channel.

In specific embodiments, a second ratio of a transmit signal power level on the first cell relative to the second cell based, at least in part, on the criterion or, alternatively, a second criterion that is different from the criterion. The controller is accordingly configured to generate a second transmit signal strength message based, at least in part, on the second ratio, which is sent for broadcast on the first cell. According to one embodiment, the memory further stores a current transmit signal power level on at least two cells, and the controller is further configured to determine whether there is inadequate transmit signal power level on one of the at least two cells and adjust the transmit signal power level using one of the at least two cells that has adequate transmit signal power level.

According to one embodiment, the communication system 100 is a Universal Mobile Telecommunication Service (UMTS) communication system that operates in accordance with the 3GPP (Third Generation Partnership Project), or W-CDMA (Wideband Code Division Multiple Access), standards, which provide a compatibility standard for UMTS air interfaces and which standards are hereby incorporated herein in their entirety. The standards specify wireless telecommunications system operating protocols, including radio system parameters, call processing procedures, and provision of a broadcast-multicast service, that is, a Multimedia Broadcast/Multicast Service (MBMS), in 3GPP (Third Generation Partnership Project) TS (Technical Specification) 23.246, TS 22.146, TS 25.346, and TS 29.846, which specifications are hereby incorporated herein in their entirety. In a UMTS communication system such as communication system 100, a communication channel comprises a logical and/or a transport channel that is mapped to a spread spectrum physical channel that uses orthogonal spreading and random scrambling.

In another embodiment of the present invention, communication system 100 may be a Code Division Multiple Access (CDMA) 2000 communication system that operates in accordance with the 3GPP2(Third Generation Partnership Project 2) standards. The 3GPP2 standards provide a compatibility standard for CDMA 2000 air interfaces (both 1X and DO) and specify wireless telecommunications system operating protocols, including radio system parameters, call processing procedures. The 3GPP2 standards further specify provision of a broadcast-multicast service, that is, a Broadcast-Multicast Service (BCMCS). BCMCSs are described in detail in the 3GPP2 (Third Generation Partnership Project Two) X.P0022, A.S00019, C.S0054 and S.R0083 specifications, which specifications are hereby incorporated herein in their entirety and copies of which may be obtained from the 3GPP2 via the Internet or from the 3GPP2.

In yet other embodiments of the present invention, communication system 100 may operate in accordance with any other wireless telecommunication system, such as but not limited to a Time Division Multiple Access (TDMA) communication system, a Wireless Local Area Network (WLAN) communication system as described by the IEEE (Institute of Electrical and Electronics Engineers) 802.xx standards, for example, the 802.11, 802.15, 802.16, or 802.20 standards, or an Orthogonal Frequency Division Multiple Access (OFDM) communication system.

As noted above, UE 102 subscribes to an MBMS service provided by communication system 100. The MBMS service provides for a conveyance of MBMS data, via a multicast or a unicast communication session and typically in a format of Internet Protocol (IP) data packets, to each subscribed UE. As is known in the art, when communication system 100 has MBMS data to provide to subscribers to the MBMS service, network controller 130 may determine to establish, in each coverage area, that is, at each Node B 120, 123, 126, a Point-To-Multipoint (PTM) communication channel or a Point-To-Point (PTP) channel to each recipient in the coverage area.

When UE 102 is soft combining MBMS transmissions from multiple cells, the UE maintains, in the at least one memory device 106 of the UE, an MBMS Active Set or a Neighbor List. The MBMS Active Set (or Neighbor List) comprises a cell identifier and/or one or more of a logical, transport, and/or physical channel, typically a pilot channel such as a CPICH, associated with serving cell of Node B 123 and each cell of one or more neighbor Node Bs, such as cells of Node Bs 120 and 126, that are engaged in soft handoff with the UE, that is, that may be simultaneously involved in a communication session with the UE and that are potential candidates for handoff or cell reselection by the UE. As part of soft handoff, UE 102 monitors the logical, transport, and/or physical channel associated with each MBMS Active Set cell. When the UE is actively engaged in an MBMS session and receives MBMS data via two or more of the MBMS Active Set cells, the UE may increase the transmission gain and reduce an error rate by soft combining MBMS data received via each of the two or more MBMS Active Set cells.

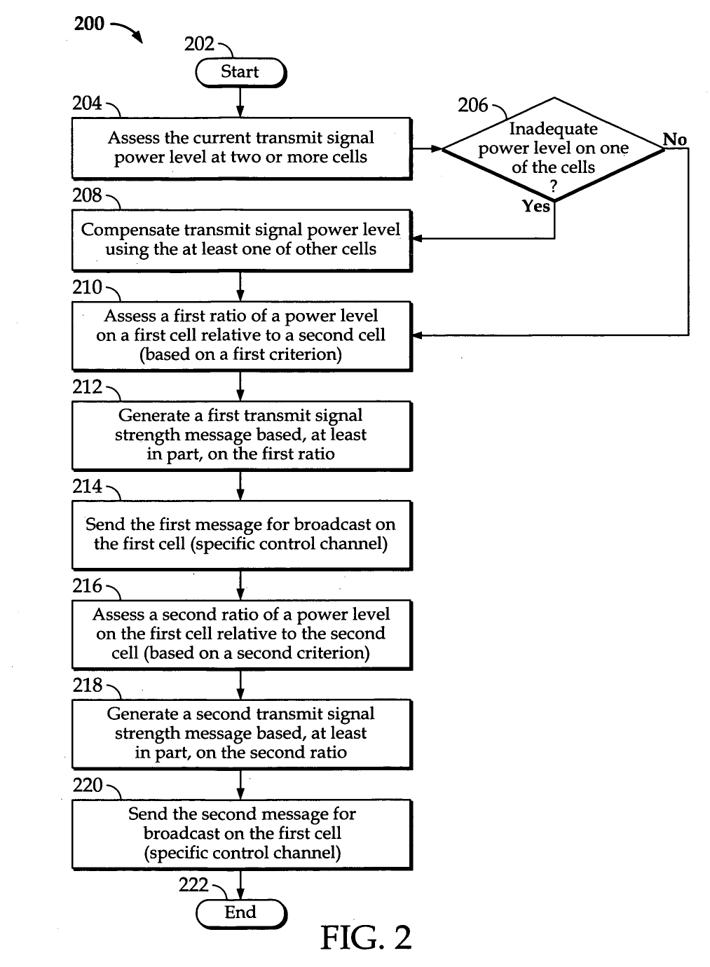

Turning now to FIG. 2, a flow chart diagram of a transmit process according to an embodiment of the invention is shown and indicated generally at numeral reference 200. Although the process shown is preferably implemented at a network controller, there may be other implementations of each of the processes shown that are better for other components in the infrastructure in the communication system. These processes shown, thus, can be implemented fully or partially at any of the components within the system. Moreover, as one skilled in the art can readily appreciate, any of the processes shown can be altered in multiple ways to achieve the same functions and results of the various teachings described. As a result, these processes shown are one exemplary embodiment of multiple variation embodiments that may not be specifically shown. Thus, the processes shown are directed to the system, and each of them may be altered slightly to accommodate any of the components in the communications system. These other embodiments, however, are within the scope of the various teachings described.

In light of this, this particular transmit process 200 starts 202 with an assessment 204 of the current transmit signal power level at two or more cells, such as a first and second cell. A determination 206 is made as to whether there is inadequate power level on one of the cells. If the cell does not have sufficient power to transmit MBMS data at a desired power level, the transmit signal power level of the inadequate cell is compensated 208 using the other one or more cells that have adequate power levels. The compensation 208 may be accomplished, for example, by transmitting MBMS data at a higher power level on one or more of the cells that have sufficient power to transmit MBMS data at their desired power levels. In this way, the cells with adequate power transmit at higher power levels than when all cells have adequate power, and the cells with adequate power compensate for cells with inadequate power to improve the coverage area of MBMS data.

If, otherwise, there is not any inadequate power level on one of the cells, a first ratio of a power level on a first cell relative to a second cell is assessed 210, specifically in one embodiment the ratio is based on an optional first criterion. A first transmit signal strength message is generated 212, which is based, at least in part, on this first ratio. According to one embodiment, the first transmit signal strength message is sent 214 to the UE on the first cell optionally using specific control channels, such as a broadcast control channel or a multicast control channel. The transmit signal strength message preferably expresses the power ratio in units of decibels. In a specific embodiment, a second ratio of a power level on the first cell relative to the second cell is also assessed 216. In one embodiment, this second ratio is also assessed based on the same first criterion as the first ratio or a second criterion that is different from the first criterion. Accordingly, a second transmit signal strength message is generated 218 based, at least in part, on the second ratio and sent 220 for broadcast on the first cell. The process ends 222 at this point.

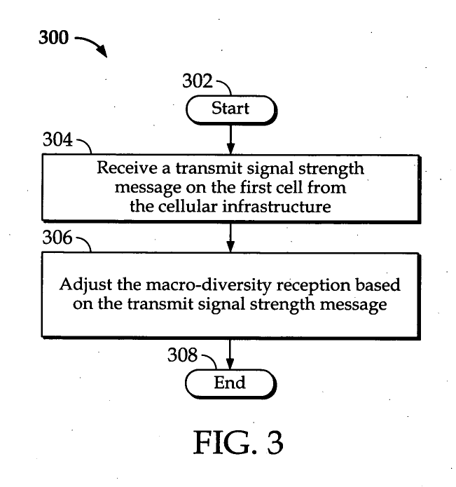

Referring now to FIG. 3, a flow chart diagram of an adjustment process according to an embodiment of the invention is shown and indicated generally at numeral reference 300. This particular adjustment process 306 shown starts with a receipt 304 of a transmit signal strength message on the first cell from the cellular infrastructure. Responsive to this message, a macro-diversity reception is adjusted 306 based on the transmit signal strength message. In specific embodiments, the macro-diversity reception can be adjusted 306 to improve reception performance. Cell selection, soft combining, and/or selection combining, as a result, may be improved.

Specifically, the UEs determine the received power level of the CPICH of a neighboring cell and use the transmit signal strength message to determine the power that the MBMS data will be received at from the neighboring cell. Cell selection may be improved, for example, by selecting the neighbor cells for macro-diversity combining that have the greatest received power at the UE. Soft combining may be improved when the UE weights (e.g., multiplies) each of the MBMS data signals received from each of the macro-diverse cells with a factor proportional to the received MBMS signal power from each cells, and then combines the weighted signals. Selection combining may be improved by using those cells with greatest average receive power as the cells to selection combine. The process 300 is completed 308 at this point.

Through the various embodiments, an improved technique that, among other things, provides a more efficient way for adjusting macro-diversity reception while accommodating the complexity of Multimedia Broadcast and Multicast Services. The network not only signals the power offset of the Multimedia Broadcast and Multicast Services, but also the neighboring cell's related power offset to the serving cell. During decoding, the UE is enabled to read this power offset information for the current cell and possibly a neighbor cell to provide improved macro-diverse reception.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
generating a transmit signal strength message using a first cell based, at least in part, on transmit signal power levels of the first cell and a second cell;
sending the transmit signal strength message for broadcast through the first cell.

2. The method according to claim 1 further comprising:
assessing a ratio of a transmit signal power level on the first cell relative to the second cell based, at least in part, on a criterion;
generating the transmit signal strength message based, at least in part, on the ratio.

3. The method according to claim 1 further comprising:
assessing a second ratio of a transmit signal power level on the first cell relative to the second cell based, at least in part, on the criterion;
generating a second transmit signal strength message based, at least in part, on the second ratio;
sending the second transmit signal strength message for broadcast through the first cell.

4. The method according to claim 1 further comprising:
assessing a second ratio of a transmit signal power level on the first cell relative to the second cell based, at least in part, on a second criterion that is different from the criterion;
generating a second transmit signal strength message based, at least in part, on the second ratio;
sending the second transmit signal strength message for broadcast on the first cell.

5. The method according to claim 1 further comprising, prior to assessing a ratio of a transmit signal power level on a first cell relative to a second cell based, at least in part, on a criterion:
assessing a current transmit signal power level of the first cell;
assessing a current transmit signal power level of the second cell.

6. The method according to claim 1 further comprising, prior to assessing a ratio of a transmit signal power level on a first cell relative to a second cell based, at least in part, on a criterion:
assessing a current transmit signal power level of the first cell;
assessing a current transmit signal power level of the second cell.
determining whether there is inadequate transmit signal power level on one of the first and second cells to provide an inadequate cell;
compensating the transmit signal power level of the inadequate cell.

7. The method according to claim 1 further comprising, prior to assessing a ratio of a transmit signal power level on a first cell relative to a second cell based, at least in part, on a criterion:
assessing a current transmit signal power level on at least two cells;
determining whether there is inadequate transmit signal power level on one of the at least two cells to provide an inadequate cell;
compensating the transmit signal power level of the inadequate cell.

8. The method according to claim 1, wherein the ratio of the transmit signal power level comprises an integer value.

9. The method according to claim 1, wherein sending the transmit signal strength message for broadcast through the first cell further comprises:
sending the transmit signal strength message for broadcast using the first cell over any one or more channel selected from a group of a broadcast control channel and a multicast control channel.

10. A method comprising:
receiving a transmit signal strength message based, at least in part, on transmit signal power levels on a first cell and a second cell;
adjusting macro-diversity reception based, at least in part, on the transmit signal strength message.

11. The method according to claim 10 further comprising:
receiving the transmit signal strength message based, at least in part, on a ratio of a transmit signal power level on the first cell relative to the second cell.

12. The method according to claim 10, wherein adjusting macro-diversity reception based, at least in part, on the transmit signal strength message further comprises:
using the transmit signal strength message to determine the received power of an MBMS signal;
selecting cells to macro-diversity combine.

13. The method according to claim 10, wherein adjusting macro-diversity reception based, at least in part, on the transmit signal strength message further comprises:
using the transmit signal strength message to determine the received power of an Multimedia Broadcast and Multicast Services signal;
adjusting soft-combing weights used in the macro-diversity reception.

14. An apparatus comprising:
a memory having transmit signal power levels of a first cell and a second cell stored therein;
a controller that is operably coupled to the memory and that is configured to generate a transmit signal strength message that is sent through the first cell based, at least in part, on the transmit signal power levels of the first cell and the second cell.

15. The apparatus according to claim 14, wherein the memory further comprises a ratio of a transmit signal power level on the first cell relative to the second cell based, at least in part, on a criterion stored therein and the controller is further configured to generate the transmit signal strength message based, at least in part, on the ratio.

16. The apparatus according to claim 14, wherein the memory further comprises a second ratio of a transmit signal power level on the first cell relative to the second cell based, at least in part, on the criterion stored therein and where the controller is further configured to generate a second transmit signal strength message based, at least in part, on the second ratio and send the second transmit signal strength message for broadcast on the first cell.

17. The apparatus according to claim 14, wherein the memory further comprises a second ratio of a transmit signal power level on the first cell relative to the second cell based, at least in part, on a second criterion that is different from the criterion and where the controller further configured to generate a second transmit signal strength message based, at least in part, on the second ratio and send the second transmit signal strength message for broadcast on the first cell.

18. The apparatus according to claim 14, wherein the memory further comprises a current transmit signal power level on at least two cells stored therein and where the controller is further configured to determine whether there is inadequate transmit signal power level on one of the at least two cells and adjust the transmit signal power level using one of the at least two cells that has adequate transmit signal power level.

19. The apparatus according to claim 14, wherein the ratio of the transmit signal power level comprises an integer value.

20. The apparatus according to claim 14, wherein the transmit signal strength message for broadcast on the first cell comprises at least one of a broadcast control channel and a multicast control channel.
